(19) United States
(12) Patent Application Publication
(10) Pub. No.: US 2019/0216144 A1
(43) Pub. Date: Jul. 18, 2019

(54) Handy Glove

(71) Applicant: James York, Wattsburg, PA (US)

(72) Inventor: James York, Wattsburg, PA (US)

(21) Appl. No.: 15/871,993

(22) Filed: Jan. 16, 2018

(51) Int. Cl. A41D 19/00; A41D 27/08; F21V 23/04; F21L 4/08; F21V 21/14; G02B 7/04

(52) U.S. Cl. CPC A41D 19/0024; A41D 27/085; F21V 23/0414; F21Y 2115/10; F21V 21/14; G02B 7/04; F21L 4/08

(57) ABSTRACT

The invention provides a device comprising a glove, wrist coupler, finger sleeve, light emitter, and actuator for a hands-free illumination of an area. The device may be worn on a user's hand, where an adjustable light mount may be configured.

The glove may have a wrist coupler attached to the end in the vicinity of the wrist to allow for the storage of batteries. The finger sleeve may be configured to receive the index finger of the user's hand. The light emitter is directed away from the first end of the panel and is attached to an adjustable light mount. The actuator may be electrically coupled to the light emitter. The light emitter is turned on or off when the actuator is actuated.

### CROSS-REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR

Not Applicable

### BACKGROUND

Unless otherwise indicated herein, the materials described in this section are not prior art to the claims in this application and are not admitted to be prior art by inclusion in this section.

### 1. Field of the Invention

The present invention generally relates to illuminating devices. More specifically, the present invention relates to illuminating devices for allowing hands-free illumination of an area.

### 2. Description of Related Art

Illuminated gloves typically have a light source that broadly illuminates the gloves themselves through the use of a polymer lens or light conducting fibers. This cause the illumination from the system to be broadly distributed across the back palm of the glove. While, this broad distribution may make it easier for a person wearing these gloves to be visible to others, such as a jogger running alongside a dark road, it does not allow a specific area to be illuminated. Other gloves may have lights in a fixed location such as along the knuckle portion of the hand to provide illumination. These gloves typically provide a power source integrated within the glove to illuminate the lights. Other gloves have an elastic sleeve mounted on their upper side for holding a flashlight. In general, these illuminating gloves typically either only illuminate the gloves themselves or one area in a fixed direction.

Accordingly, there is a need for a glove that may illuminate a specific area of interest to the user regardless of the position of the user's hand that is inexpensive, lightweight, or easy to use. The device described in this patent application fulfills at least one of these needs or creates other utility.

### BRIEF SUMMARY OF THE INVENTION

It is a principal object to solve at least one of the disadvantages with other attempted solutions or to create other utility by providing a device for a hands-free illumination of a specific area. The device includes a panel that has a first end, a second end, a first lateral edge, a second lateral edge, a top surface and a bottom surface. A wrist coupler is attached to the first end. A finger sleeve is attached to the second end and positioned adjacent to the first lateral edge. A light emitter, which is attached to the wearable light mount, is directed away from the first end of the panel. An actuator is electrically coupled to the light emitter, which is turned on or off when the actuator is activated.

An embodiment of the disclosure generally comprises a wearable light mount configured to be positioned on a glove that is worn on the user's hand. The wearable light mount includes a panel with a first end, a second end, a first lateral edge, a second lateral edge, a top surface and a bottom surface. The panel is configured to be positioned on top of the hand. A wrist coupler is attached to the first end, which is configured to be extended around the wrist of a person to retain the panel on the hand to form an adjustable loop of a selected circumference.

The finger sleeve is positioned adjacent to the first lateral edge on the second end. The finger sleeve is configured to receive an index finger of the user's hand. A light emitter is attached to the wearable light mount and is directed away from the first end of the panel. An actuator is electrically coupled to the light emitter and attached to the wearable light mount. The light emitter is turned on or off when the actuator is activated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The accompanying drawings, which are incorporated in and constitute a part of this specification, illustrate several aspects described below.

FIG. 1 is a top back view of the device of the present invention in which at least one of the embodiments of this invention is implemented.

FIG. 2 is a bottom palm view of the device of the present invention in which at least one of the embodiments of this invention is implemented.

FIG. 3 is a left side view of the device of the present invention in which at least one of the embodiments of this invention is implemented.

FIG. 4 is a front view of the device of the present invention where directional arrows indicate possible positions of the light in which at least one of the embodiments of this invention is implemented.

FIG. 5 is a top back view of the device of the present invention where dashed (phantom) lines represent components below the surface of the device and an optional pocket in which at least one of the embodiments of this invention is implemented.

FIG. 6 is a top back view of the device of the present invention without the user's hand shown with a magnifying glass extending from a pocket in which at least one of the embodiments of this invention is implemented.

### DETAILED DESCRIPTION OF THE INVENTION

It is to be understood that this invention is not limited to any particular embodiment described, which may vary. Also, it is to be understood that the terminology used herein is for the purpose of describing particular embodiments only, and is not intended to be limiting, since the scope of this invention will be limited only by the appended claims.

In the following detailed description, numerous specific details are set forth in order to explain and provide a thorough understanding of the present invention. However, it is apparent that the present invention may be practiced without all of these specific details. Thus, all illustrations of the drawings are for the purpose of describing versions of the present invention, and are not intended to limit the scope of the invention.

In the following section, the present invention is described fully by referencing the details in the enclosed drawings, which illustrate certain embodiments of the invention. The numbers shown in this specification refer to the corresponding numbers in the enclosed drawings. The terminology used is to describe the particular embodiment shown and is not intended to limit the scope of the invention. The invention may also be embodied in many other forms in addition to the embodiments shown. Thus, the embodiments shown should not be construed as limiting, but rather, to allow a thorough and complete description of the disclosure that conveys the scope of the invention to a person having ordinary skill in the art in the field of this invention. Therefore, for the terms used herein, the singular forms “the,” “a,” and “an” are intended to include the plural forms as well as the singular forms, unless the context clearly indicates otherwise. The term “and” includes any and all combinations of one or more of the associated listed items. As used herein, the terms “comprising” and “comprises” when used in this specification, identify specific steps, integers, operations, features, components, and elements, but do not preclude the presence or addition of one or more other steps, operations, features, components, and elements. In addition, the features, components, and elements referenced may be exaggerated for clarity.

Unless otherwise defined, all scientific terms, technical terms, or other terms used herein have the same meaning as the term that is understood by one having ordinary skill in the art in the field of this invention. It is also understood that these terms, including their dictionary meaning, should be understood as having the meaning, which is consistent with their definitions in the related relevant art. In addition, the present disclosure is not to be interpreted in an idealized or overly formal sense unless expressly stated so herein. Constructions or functions that are well known in the art may not be fully described in detail for brevity.

In describing the invention, it is understood that a number of steps and methods may be disclosed. Each of these may have individual benefit. Also, each may be used in conjunction with at least one or more of the disclosed steps and methods. Therefore, this description will refrain from stating each and every possible combination of the individual steps and methods for the sake of brevity. Regardless, the specification and related claims should be understood with the combinations that are entirely within the scope of the claims and inventions.

The disclosure in this invention are examples of how it may be implemented and are not intended to limit the scope of the invention to the specific embodiments shown in the accompanying drawings or the description provided herein. All illustrations are for the purpose of describing selected versions of the present invention and are not intended to limit the scope of the present invention. The present invention will now be described by example in the following paragraphs by referencing the accompanying drawings, which represent embodiments and alternative embodiments. All illustrations of the drawings are for the purpose of describing selected versions of the present invention and are not intended to limit the scope of the present invention.

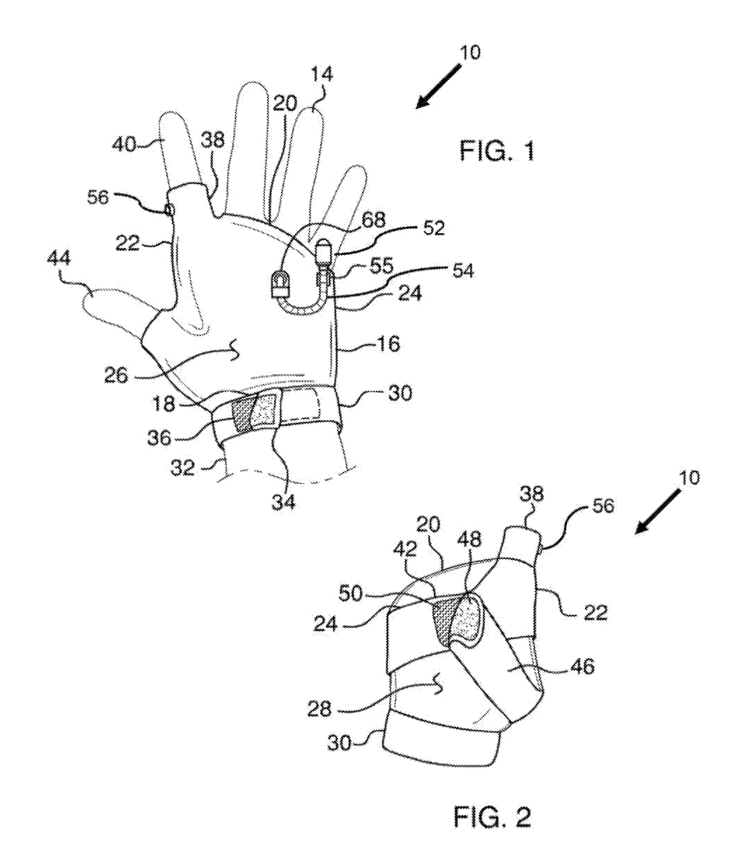

With reference now to the drawings, and in particular to FIGS. 1 through 6 thereof, an illuminating device embodying the principles and concepts of an embodiment of the disclosure and generally designated by the reference numeral glove 10 will be described.

FIG. 1 shows a glove 10 with a connected lighting source as viewed from the back or dorsal side of the hand. As shown in FIG. 1, the wearable light mount includes a panel 16 which has a first bottom end 18, a second top end 20, a first lateral left edge 22, a second lateral right edge 24, and a top surface 26, and a bottom surface with dimensions that allow it to cover the user's hand from the vicinity of the proximal phalanx of the thumb, the proximal phalanx of and index finger, and the base of the other fingers in the vicinity of the metacarpophalangeal joint to the wrist of the user in the vicinity of the distal ends of the radius and ulna, said panel being configured to be positioned on top of the user's hand.

The panel 16, which is configured to be positioned on top of the hand 14, may be comprised of a resiliently stretchable material selected from the group consisting of cotton, leather, neoprene, rubber, and latex.

Also, as shown in FIG. 1, a wrist coupler 30 is attached to the first bottom end 18. The wrist coupler 30 is configured to be extended around a user's wrist 32 to retain the panel 16 on the hand. The wrist coupler 30 comprises a first right end 34 and a second left end 36 to form an adjustable loop of a selected circumference. The adjustable loop may be configured to be extended around a wrist of a person of approximately three inches to ten inches in circumference to retain said panel on the hand.

The first right end 34 may comprise the loop side of a hook and loop fastener, such as Velcro, while the second left end 36 may comprise the hook side of a hook and loop fastener. In addition to a hook and loop fastener, the connection between the first end 34 and second end 36 may be made with snaps, buttons, hooks, magnets, or other conventional fastening means.

In addition, as shown in FIG. 1, at least one finger sleeve 38 that is attached to the second end 20 and positioned adjacent to the first lateral edge 22 may partially cover the user's index finger, which is also known as the pointer finger, that is located between the thumb and the middle finger. At least one finger sleeve 38 is configured to receive a finger of the hand 40, such as the index finger as shown in FIG. 1. The at least one finger sleeve 38 may be approximately one-half inch in diameter and approximately two-inches long. The at least one finger sleeve 38 may be attached to said second end, where said finger sleeve may be positioned adjacent to said first lateral edge, and said finger sleeve may be configured to receive an index finger of the hand.

The glove 10 may also include additional sleeves for receiving additional fingers. Additional sleeves may be desirable for specific uses of the glove 10. All fingers of the hand 14 may be at least partially exposed when the glove 10 is positioned on the hand 14 to allow for easy grasping of tools and articles. The thumb of the hand 44, as shown in FIG. 1, may also protrude from the glove 10.

Furthermore, as shown in FIG. 1, the swivel surface attachment 68 is connected to the top surface 26. Also as shown in FIG. 1, the articulating member 54 is held in place by clip 55, which is attached to the glove 10. In its stationary position, light emitter 52 may be directed away from the first bottom end 18 of the glove 10. This allows the light emitter 52 to shine light in the direction of the user's fingers. Also shown in FIG. 1 is light actuator 56.

FIG. 2 shows the glove 10 and connected lighting source as viewed from the front side of the hand, which is also known as the palm-side or palmar side. As shown in FIG. 2, a first mating member 48 and a second mating member 50 connect together to secure the glove 10 to the user's hand and wrist. In at least one embodiment of the invention, the first mating member 48 may be the loop side of a Velcro fastener, and the second mating member 50 may be the loop side of a Velcro fastener. In at least one other embodiment of the invention the first mating member 48 and the second mating member 50 may be connected together from the group consisting of snaps, buttons, hooks, magnets, and other conventional fastening means.

As shown in FIG. 2, the first end of a strap 46 is secured to the second end of a strap 42. The first end of a strap 46 has a first mating member 48, which attaches to the second end of the strap 42 by way of a second mating member 50 to further stabilize the device on the user's hand. The first mating member 48 and the second mating member 50 may comprise hook and loop mating members. The wrist coupler 30, finger sleeve 38, the band comprised of the first end of the strap 46 and the second end of the strap 42 may be each comprised of a resiliently stretchable material selected from the group consisting of cotton, leather, neoprene, rubber, and latex. Also, as shown in FIG. 2, the band comprising the first end of the strap 46 and the second end of the strap 42 extends between the first lateral edge 22 and the second lateral edge 24.

The glove 10 also comprises a bottom surface 28 and a top surface 20. The band is located below the finger sleeve 38 and above the wrist coupler 30. Also, as shown in FIG. 2, the band may extend across the wearer's palm when the glove 10 is being worn. A strap 46 is attached to the first lateral edge 22. The strap 46 is releasably coupled to the band 42 such that a thumb opening configured for receiving the thumb 44 is positioned between the band 42 and the strap 46. Also as shown in FIG. 2, a finger sleeve 38 is attached to the second end 20. Also shown in FIG. 1 is light actuator 56.

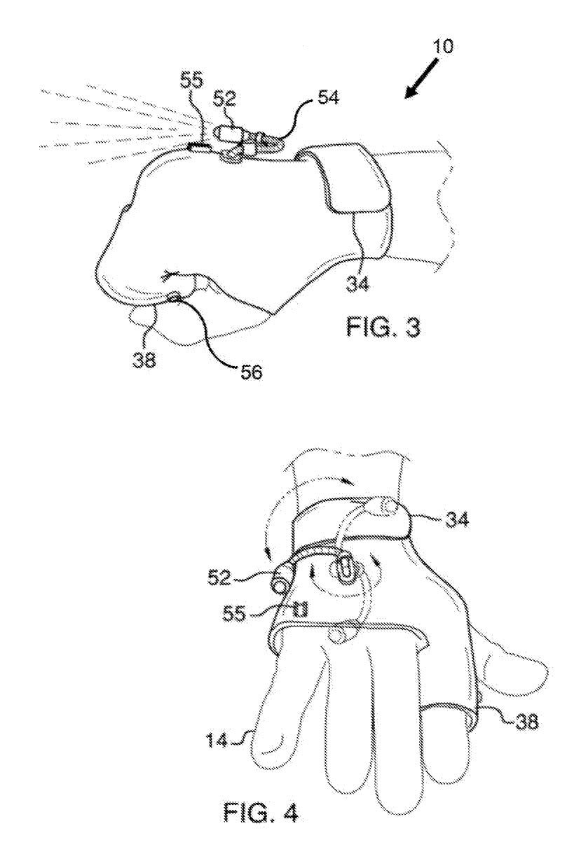

As shown in FIG. 3, a light emitter 52 is attached to the articulating member 54, which is attached to the swivel surface attachment 68. Also as shown in FIG. 3, the articulating member 54 is held in place by clip 55, which is attached to the glove 10. FIG. 3 also shows finger sleeve 38, and the adjustable loop 34 of the wrist coupler that may be configured to extend around a wrist of the user to a circumference of approximately three inches to ten inches in order to retain said panel on the hand, where the width of the wrist coupler may vary from approximately one-quarter of an inch to approximately two inches. Also shown in FIG. 1 is light actuator 56.

FIG. 4 shows the adjustable loop 34 of the wrist coupler, along with the light emitter 52 and clip 55. The directional arrows in this figure illustrates how the light can be swiveled to a number of different locations. FIG. 4 also shows the hand 14 of the user and the finger sleeve 38.

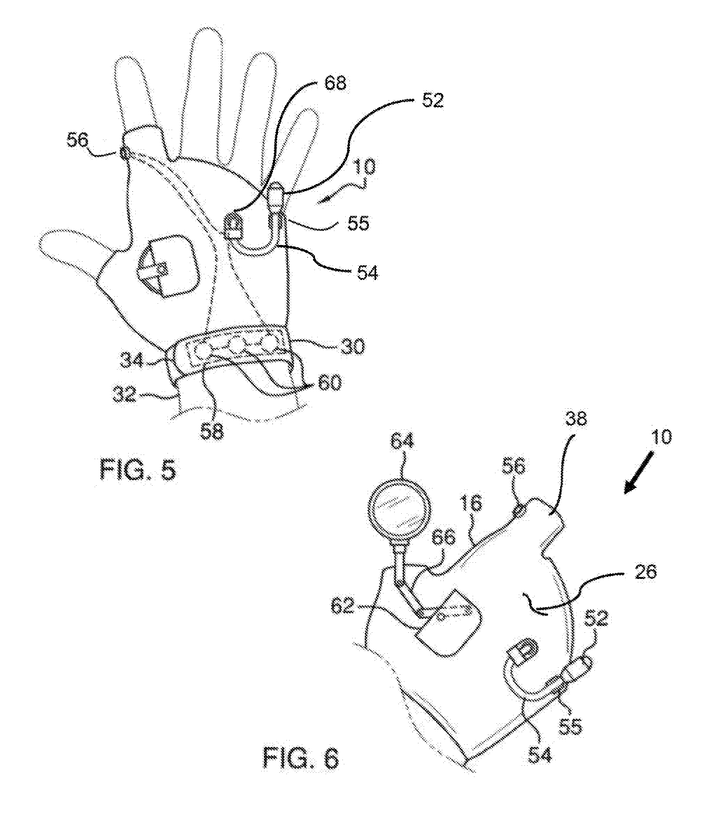

FIG. 5 shows an illuminating glove 10 generally comprises a wearable light emitter 52 mounted to the swivel surface attachment 68 that is configured to be positioned on a user's hand. Also, as shown in FIG. 5, a power supply 58 is electrically coupled to the light emitter 52 and to at least one actuator 56. The at least one actuator 56 may be attached to said wearable light mount and electrically coupled to said light emitter, which may be turned on or off when said actuator is actuated.

The power supply 58 may comprise at least one battery 60 mounted in the glove 10. The battery 60 is removably inserted within the wrist coupler 30. However, it should be understood that the light emitter 52 may be detachable from the top surface 26 or rotatably coupled to the top surface by an attachment 68.

Also, as shown in FIG. 5, the wrist coupler 30 is configured to be extended around the wrist of a person 32. The wrist coupler 30 includes an adjustable loop 34. In addition, the glove 10 may include additional sleeves for receiving additional fingers. However, only one sleeve is required for stability. Also, having only one single sleeve allows for easier positioning of the device over a glove being worn by a person. In addition, FIG. 5 shows the location of where at least one button switch actuator 56 may be mounted to enable the user to easily turn the light emitter 52 to either turn on, off, or to adjust the intensity.

Furthermore, FIG. 5 shows dashed (phantom) lines through the center of the glove 10. These lines depict the wiring that connects at least one battery 60 as shown in FIG. 5, to the swivel surface attachment 68. In at least one embodiment of the invention, at least one battery 60 may be located within light emitter 52. The battery 60 that is inserted within the wrist coupler 30 may be rechargeable. The wiring continues from swivel surface attachment 68 through articulating member 54 to light emitter 52.

As shown in FIG. 6, articulating member 54 is held in place by clip 55, which is attached to the surface 26 of the glove 10. As shown in FIG. 6, the light emitter 52 has an articulating member 54 allowing the light emitter 52 to be aimed in various directions. The articulating member 54 may comprise a bendable material which retains its shape once bent in a particular configuration. A clip 55 may be attached to the top surface 26 to retain the articulating member and to further retain the light emitter 52 in a forward directed orientation.

An actuator 56 is mounted on panel 16 and electrically coupled to the light emitter 52. The light emitter 52 is turned on or off when the actuator 56 is actuated. The actuator 56 may be positioned on the sleeve 38, as shown in FIG. 6, to facilitate actuation by the thumb 44.

In an alternative embodiment shown in FIG. 6, a pocket 62 may be attached to the top surface 26 of the glove 10. The pocket may be used for a variety of functions, such as holding small articles such as coins, dollar bills, a smart watch, Apple Watch, Garmin Watch, other types of watches, a GPS device, cellular phone, compass, etc. Alternatively, instead of holding a light and its associated connectors, the swivel surface attachment 68 may also allow small articles to be attached such as a smart watch, Apple Watch, Garmin Watch, other types of watches, a GPS device, cellular phone, compass, etc. For example, as shown in FIG. 6, a magnifying glass 64 with an articulated arm 66 may be attached to the glove 10 and may fold into the pocket 62. The magnifying glass 64 is removably positioned in the pocket 62. If included, the magnifying glass 64 may be positioned in such a manner to magnify small objects in a work area. The magnifying glass 64 can be stored in the pocket 62.

The actuator 56 may be positioned on the sleeve 38. The light emitter 52, which is inserted within the wrist coupler 30, may contain a light emitting diode (LED). Also, more than one actuator 56 may be used. For example, if the glove had more than one actuator, it's possible that the lighting level could be adjusted. Also, the light emitter 52 may be adjustable for zooming light into a narrow beam or a wide beam.

In at least one additional embodiment of the invention, actuator 56 may be eliminated, so that when two fingers are placed together the light emitter 52 may illuminate. For example, if a magnet is placed on the index finger and a sensor is placed on the middle finger, the light emitter 52 may be illuminated when these two fingers are placed together. This may eliminate the requirement of having to depress actuator 56. This may also allow the LED light to be turned on and off while the user is holding an object, since the user's thumb would not be required to turn the light on and off.

In at least one additional embodiment of the invention, the glove 10 may have full fingers to keep the hand warm when working in cold temperatures or to keep the hand clean when working in dirty environments or both.

In at least one other additional embodiment of the invention, the articulated arm 66 may be replaced by a gooseneck arm or snake light that offers greater flexibility in setting the position of the light 52. This may increase the number of angles that can be used to magnify an object. The basic principle of this invention is that the actuator and the gooseneck arm or snake light may be integrated into various glove designs. These may include a sterile glove that is used for medical procedure, so that a surgeon could use the glove 10 with an illuminating device.

In at least yet one other embodiment of the invention, the glove 10 may be worn on either the right or left hand. In the configuration where the glove 10 is worn on the right hand, the swivel surface attachment 68, articulating member 54, clip 55, and light emitter 52 will be on the back of the hand. While in the configuration where the glove 10 is worn on the left hand, the swivel surface attachment 68, articulating member 54, clip 55, and light emitter 52 will be on the palm of the hand.

In at least one other embodiment of the invention, a separate glove 10 may be manufactured for both the right and left hand, so that the swivel surface attachment 68, articulating member 54, clip 55, and light emitter 52 may be positioned on the back of both the left and right glove.

In at least one additional embodiment of the invention, the swivel surface attachment 68, articulating member 54, clip 55, and light emitter 52 may be attached to the glove 10 on both the palm side and the back side of the hand.

In at least one further embodiment of the invention, the swivel surface attachment 68, articulating member 54, clip 55, and light emitter 52 may be attached to the glove 10 at the outside edge of the hand near the little finger, which is also known as the pinky finger, in the vicinity of the second lateral edge 24, as shown in FIG. 1, so that the glove can be worn on either the left or right hand.

With respect to the above description, it is to be realized that the optimum dimensional relationships for the parts of an embodiment enabled by the disclosure is, to include variations in size, materials, shape, form, function and manner of operation, device and use, which are deemed readily apparent and obvious to one skilled in the art, and all equivalent relationships to those.

Although the invention has been explained in relation to its at least one embodiment, it is to be understood that many other possible modifications and variations can be made without departing from the spirit and scope of the invention as hereinafter claimed. All of these embodiments and the invention disclosed herein are intended to be within the scope herein disclosed. These and other embodiments of the invention will become readily apparent to those skilled in the art from the detailed description of the embodiments having reference to the attached figures, the embodiments not being limited to any particular embodiments disclosed. Also, the invention disclosed herein suitably may be practiced in the absence of any element which is not specifically disclosed herein.

What is claimed is:

1. A device for illumination worn on the hand of a user, the device comprising:
a. at least one wearable light mount configured to be positioned on a user's hand, said wearable light mount comprising;
b. a panel having a first end, a second end, a first lateral edge, a second lateral edge, a top surface, and a bottom surface with dimensions that allow it to cover the user's hand from the vicinity of the proximal phalanx of the thumb, the proximal phalanx of and index finger, and the base of the other fingers in the vicinity of the metacarpophalangeal joint to the wrist of the user in the vicinity of the distal ends of the radius and ulna, said panel being configured to be positioned on top of the user's hand, where material for said panel may be comprised of a resiliently stretchable material selected from the group consisting of cotton, leather, neoprene, rubber, and latex;
c. a wrist coupler being attached to said first bottom end, said wrist coupler being configured to be extended around a wrist of a person of approximately three inches to ten inches in circumference to retain said panel on the hand, where the width may vary from approximately one-quarter of an inch to approximately two inches;
d. at least one finger sleeve, said finger sleeve approximately one-half inch in diameter and approximately two-inches long, being attached to said second end, said finger sleeve being positioned adjacent to said first lateral edge, said finger sleeve being configured to receive an index finger of the hand;
e. at least one light emitter being attached to said wearable light mount, said light emitter being directed away from said first end of said panel; and
f. at least one actuator being electrically coupled to said light emitter, said light emitter being turned on or off when said actuator is actuated, said actuator being attached to said wearable light mount;
g. means for connecting together said wearable light mount, said at least one panel, said wrist coupler, said at least one finger sleeve, said at least one light emitter, and at least one actuator;
h. means for a user wearing the assembled combination of the wearable light mount, said at least one panel, said wrist coupler, said at least one finger sleeve, said at least one light emitter, and at least one actuator; wherein when the user illuminates an area of interest; and
i. means for allowing a user to illuminate an area of interest.

2. The device according to claim 1, wherein said wrist coupler includes an adjustable loop and a connector for retaining said adjustable loop at a selected circumference.

3. The device according to claim 2, further comprising a band being attached to and extending between said first and second lateral edges, said band traversing said bottom surface, said band being attached to said finger sleeve and being spaced from said wrist coupler to facilitate the extension of a thumb of the hand between said band and said wrist coupler.

4. The device according to claim 3, further comprising a strap being attached to said first lateral edge, said strap being releasably coupled to said band such that a thumb opening configured for receiving the thumb is positioned between said band and said strap, wherein all fingers of the hand are exposed when said device is positioned on the hand.

5. The device according to claim 4, wherein said strap is secured to said band with a first mating member attached to said strap and a second mating member attached to said band.

6. The device according to claim 5, wherein said light emitter is positioned adjacent to said second lateral edge.

7. The device according to claim 6, wherein said actuator is positioned on said sleeve to facilitate actuation by a thumb.

8. The device according to claim 7, further comprising a power supply being electrically coupled to said light emitter and to said actuator, said power supply comprising at least on battery mounted in said wearable light mount.

9. The device according to claim 8, wherein said at least one battery is removably inserted within said wrist coupler.

10. The device according to claim 9, further comprising a pocket being attached to said top surface of said panel.

11. The device according to claim 10, further comprising a magnifying glass with an articulated arm being attached together, said articulated arm being attached to said panel within said pocket, said magnifying glass being removably positioned in said pocket.

12. The device according to claim 11, further comprising a pocket being attached to said top surface of said panel.

13. The device according to claim 12, further comprising a magnifying glass with an articulated arm being attached together, said articulated arm being attached to said panel within said pocket, said magnifying glass being removably positioned in said pocket.

14. An illuminating device configured for being worn by a person, said device comprising:
a. a wearable light mount configured to be positioned on a user's hand, said wearable light mount including;
b. a panel having a first end, a second end, a first lateral edge, a second lateral edge, a top surface and a bottom surface, said panel being configured to be positioned on top of the hand, said panel being comprised of a resiliently stretchable material;
c. a wrist coupler being attached to said first end, said wrist coupler being configured to be extended around a wrist of a person to retain said panel on the hand, said wrist coupler including an adjustable loop and a connector for retaining said adjustable loop at a selected circumference;
d. a finger sleeve being attached to said second end, said finger sleeve being positioned adjacent to said first lateral edge, said finger sleeve being configured to receive an index finger of the hand;
e. a band being attached to and extending between said first and second lateral edges, said band traversing said bottom surface, said band being attached to said finger sleeve and being spaced from said wrist coupler to facilitate the extension of a thumb of the hand between said band and said wrist coupler;
f. a strap being attached to said first lateral edge, said strap being releasably coupled to said band such that a thumb opening configured for receiving the thumb is positioned between said band and said strap, wherein all fingers of the hand are exposed when said device is positioned on the hand, said strap being secured to said band with a first mating member attached to said strap and a second mating member attached to said band, said wrist coupler, said finger sleeve, said band and said strap each being comprised of a resiliently stretchable material;
g. a light emitter being attached to said wearable light mount, said light emitter being directed away from said first end of said panel, said light emitter being positioned adjacent to said second lateral edge;
h. an actuator being electrically coupled to said light emitter, said light emitter being turned on or off when said actuator is actuated, said actuator being attached to said wearable light mount, said actuator being positioned on said sleeve to facilitate actuation by the thumb;
i. a power supply being electrically coupled to said light emitter and to said actuator, said power supply comprising at least on battery mounted in said wearable light mount, said at least one battery being removably inserted within said wrist coupler;
j. a pocket being attached to said top surface of said panel; and
k. a magnifying glass and an articulated arm being attached together, said articulated arm being attached to said panel within said pocket, said magnifying glass being removably positioned in said pocket.

15. A method of using a device for illuminating an area of interest, the device comprising the steps of:
a. providing a wearable light mount configured to be positioned on a user's hand;
b. providing a panel having a first end, a second end, a first lateral edge, a second lateral edge, a top surface and a bottom surface, said panel being configured to be positioned on top of the hand, said panel being comprised of a resiliently stretchable material;
c. providing a wrist coupler being attached to said first end, said wrist coupler being configured to be extended around a wrist of a person to retain said panel on the hand, said wrist coupler including an adjustable loop and a connector for retaining said adjustable loop at a selected circumference;
d. providing a finger sleeve being attached to said second end, said finger sleeve being positioned adjacent to said first lateral edge, said finger sleeve being configured to receive an index finger of the hand;
e. providing a band being attached to and extending between said first and second lateral edges, said band traversing said bottom surface, said band being attached to said finger sleeve and being spaced from said wrist coupler to facilitate the extension of a thumb of the hand between said band and said wrist coupler;
f. providing a strap being attached to said first lateral edge, said strap being releasably coupled to said band such that a thumb opening configured for receiving the thumb is positioned between said band and said strap, wherein all fingers of the hand are exposed when said device is positioned on the hand, said strap being secured to said band with a first mating member attached to said strap and a second mating member attached to said band, said wrist coupler, said finger sleeve, said band and said strap each being comprised of a resiliently stretchable material;
g. providing a light emitter being attached to said wearable light mount, said light emitter being directed away from said first end of said panel, said light emitter being positioned adjacent to said second lateral edge;
h. providing an actuator being electrically coupled to said light emitter, said light emitter being turned on or off when said actuator is actuated, said actuator being attached to said wearable light mount, said actuator being positioned on said sleeve to facilitate actuation by the thumb;
i. providing a power supply being electrically coupled to said light emitter and to said actuator, said power supply comprising at least on battery mounted in said wearable light mount, said at least one battery being removably inserted within said wrist coupler;
j. providing a pocket being attached to said top surface of said panel;
k. providing a magnifying glass and an articulated arm being attached together, said articulated arm being attached to said panel within said pocket, said magnifying glass being removably positioned in said pocket;
l. providing means for connecting together said wearable light mount, said at least one panel, said wrist coupler, said at least one finger sleeve, said at least one light emitter, and at least one actuator;
m. providing means for a user wearing the assembled combination of the wearable light mount, said at least one panel, said wrist coupler, said at least one finger sleeve, said at least one light emitter, and at least one actuator; wherein when the user illuminates an area of interest; and
n. providing means for illuminating an area of interest for the user.
